(19) United States
(12) Patent Application Publication
(10) Pub. No.: US 2026/0184899 A1
(43) Pub. Date: Jul. 2, 2026

(54) SILANE COUPLING AGENT SOLUTION-MODIFIED NANOMATERIAL-TOUGHENED RESIN MATRIX AND PREPARATION METHOD AND USE THEREOF

(71) Applicant: QINGDAO UNIVERSITY OF TECHNOLOGY, Qingdao, Shandong (CN)

(72) Inventors: Jiuwen BAO, Qingdao, Shandong (CN); Yinlong CAO, Qingdao, Shandong (CN); Peng ZHANG, Qingdao, Shandong (CN); Ying LI, Qingdao, Shandong (CN); Pan WANG, Qingdao, Shandong (CN); Bolong JIANG, Qingdao, Shandong (CN); Wenhuan WANG, Qingdao, Shandong (CN)

(73) Assignee: QINGDAO UNIVERSITY OF TECHNOLOGY, Qingdao, Shandong (CN)

(21) Appl. No.: 18/834,012

(22) PCT Filed: Jul. 20, 2023
(86) PCT No.: PCT/CN2023/108331

§ 371 Date: Jul. 29, 2024

(30) Foreign Application Priority Data
Jul. 17, 2023 (CN) 202310872960.6

(51) Int. Cl. C08K 9/06; C08J 3/21; C09C 1/30; C09C 1/36; C09C 3/12

(52) U.S. Cl. CPC C08K 9/06; C08J 3/212; C09C 1/3081; C09C 1/3684; C09C 3/12; C01P 2004/64; C01P 2006/12; C08J 2323/00; C08J 2363/00; C08K 2201/006; C08K 2201/011

(57) ABSTRACT

Provided is a method for preparing a silane coupling agent solution-modified nanomaterial-toughened resin matrix. In the method, a specific silane coupling agent KH560 solution is adopted to modify a nanomaterial to obtain a modified nanomaterial, and a resin matrix is toughened with the modified nanomaterial.

### CROSS-REFERENCE TO RELATED APPLICATION

This application is a national stage application of International Patent Application No. PCT/CN2023/108331, filed on Jul. 20, 2023, which claims priority of Chinese Patent Application No. 202310872960.6 filed with the China National Intellectual Property Administration on Jul. 17, 2023. The disclosure of the two applications is incorporated herein by reference in its entirety as part of the present application.

### TECHNICAL FIELD

The present disclosure relates to the technical field of composites, and in particular to a silane coupling agent solution-modified nanomaterial-toughened resin matrix and a preparation method and use thereof.

### BACKGROUND

Fiber-reinforced polymer (FRP), a material composed of a resin matrix and fiber, shows excellent mechanical and corrosion resistance properties and has been widely used in different fields. In actual engineering applications, the resin matrix is directly exposed to the external environment and protects the fibers. However, the resin matrix is generally brittle and has poor toughness, which causes the resin matrix to prematurely lose restraint and protective effect on the fibers, leading to the failure of FRP composites. Therefore, improving the mechanical properties of the resin matrix is crucial to improving the performance of the FRP composites.

Nanomaterials could effectively improve the mechanical properties and toughness of the resin matrix. However, due to the large specific surface area and high surface energy, the nanoparticles are easy to agglomerate together and cause internal defects in the matrix. As a result, improving the compatibility between the nanomaterials and the resin matrix is a key to giving full play to the reinforcement effect of the nanomaterials. In the prior art, silane coupling agents are commonly used to modify the nanomaterials, and a commonly used silane coupling agent is KH550. However, this silane coupling agent has a relatively general modification effect. Accordingly, it has become a difficult problem in the existing technology to further improve the mechanical properties of a nanomaterial-modified resin matrix.

### SUMMARY

The present disclosure is intended to provide a silane coupling agent solution-modified nanomaterial-toughened resin matrix and a preparation method and use thereof. In the present disclosure, KH560 is adopted to modify a nanomaterial, thereby further improving the mechanical properties of a resin matrix.

To achieve the above objects, the present disclosure provides the following technical solutions:

The present disclosure provides a method for preparing a silane coupling agent solution-modified nanomaterial-toughened resin matrix, including the following steps:
(1) mixing silane coupling agent KH560, ethanol, water, and acetic acid, and conducting hydrolysis to obtain a silane coupling agent solution;
(2) mixing the silane coupling agent solution obtained in step (1) with a nanomaterial, and conducting modification to obtain a modified nanomaterial; and
(3) mixing the modified nanomaterial obtained in step (2) with a resin and a curing agent, and conducting curing to obtain the silane coupling agent solution-modified nanomaterial-toughened resin matrix.

In some embodiments, the silane coupling agent solution in step (1) has a mass concentration of 2% to 4%.

In some embodiments, the silane coupling agent solution in step (1) has a pH value of 4 to 6.

In some embodiments, the nanomaterial in step (2) includes one or more selected from the group consisting of nano-titania and nano-silica.

In some embodiments, the nanomaterial in step (2) has a particle size of 10 nm to 20 nm.

In some embodiments, in step (2), a mass ratio of the nanomaterial to the silane coupling agent solution is in a range of (5-20):100.

In some embodiments, the modification in step (2) is conducted for 3 h to 6 h.

In some embodiments, in step (3), a mass ratio of the modified nanomaterial to the resin is in a range of (1-5):100.

The present disclosure further provides a silane coupling agent solution-modified nanomaterial-toughened resin matrix prepared by the method described in the above technical solutions.

The present disclosure further provides use of the silane coupling agent solution-modified nanomaterial-toughened resin matrix described in the above technical solutions in a resin matrix composite.

The present disclosure provides a method for preparing a silane coupling agent solution-modified nanomaterial-toughened resin matrix, including the following steps: (1) mixing a silane coupling agent KH560, ethanol, water, and acetic acid, and conducting hydrolysis to obtain a silane coupling agent solution; (2) mixing the silane coupling agent solution obtained in step (1) with a nanomaterial, and conducting modification to obtain a modified nanomaterial; and (3) mixing the modified nanomaterial obtained in step (2) with a resin and a curing agent, and conducting curing to obtain the silane coupling agent solution-modified nanomaterial-toughened resin matrix. In the present disclosure, a specific silane coupling agent KH560 solution is adopted to modify the nanomaterial to obtain the modified nanomaterial, and the resin matrix is toughened with the modified nanomaterial. The KH560 has two reactive groups, which could effectively modify a surface of the nanomaterial and reduce agglomeration. Meanwhile, molecular chains connected to the surface of the nanomaterial contain epoxy groups that could react with the resin, such that the molecular chains could achieve efficient ligation between the inorganic nanomaterial and the resin matrix, improve compatibility of the nanomaterial and the resin, and give full play to a toughening effect of the nanomaterial on the resin. Moreover, during the curing, the epoxy groups do not occupy reaction bond sites between the curing agent and the resin, thereby increasing a cross-linking density of the resin after curing and further improving mechanical properties of the resin matrix.

### BRIEF DESCRIPTION OF THE DRAWINGS

FIG. 1 shows a schematic flow chart for preparation of the silane coupling agent solution-modified nanomaterial-toughened resin matrix in examples of the present disclosure;

FIG. 2 shows tensile stress-strain curves of the resin matrix separately prepared in Example 1, Example 2, and Comparative Example 1 of the present disclosure; and

FIG. 3 shows tensile stress-strain curves of the resin matrix separately prepared in Example 3 and Comparative Examples 2 to 3 of the present disclosure.

### DETAILED DESCRIPTION OF THE EMBODIMENTS

The present disclosure provides a method for preparing a silane coupling agent solution-modified nanomaterial-toughened resin matrix, including the following steps:
(1) mixing silane coupling agent KH560, ethanol, water, and acetic acid, and conducting hydrolysis to obtain a silane coupling agent solution;
(2) mixing the silane coupling agent solution obtained in step (1) with a nanomaterial, and conducting modification to obtain a modified nanomaterial; and
(3) mixing the modified nanomaterial obtained in step (2) with a resin and a curing agent, and conducting curing to obtain the silane coupling agent solution-modified nanomaterial-toughened resin matrix.

Unless otherwise specified, in the present disclosure, there is no special limitations on sources of all the raw materials, and commercially-available products well known to those skilled in the art may be adopted.

In the present disclosure, a silane coupling agent KH560, ethanol, water, and acetic acid are mixed, and then subjected to hydrolysis to obtain a silane coupling agent solution.

In the present disclosure, the silane coupling agent KH560 (γ-(2,3-epoxypropoxy) propytrimethoxysilane) contains hydrolyzable groups and epoxy groups. The hydrolyzable groups are hydrolyzed and ligated to the nanomaterial, and could effectively modify a surface of the nanomaterial and reduce agglomeration. Meanwhile, the epoxy groups could react with the resin matrix without occupying reaction bond sites between the curing agent and the resin, thereby increasing a cross-linking density of the resin matrix after curing and improving its mechanical properties.

In some embodiments of the present disclosure, the water is deionized water. In some embodiments of the present disclosure, a mass ratio of the ethanol to the water is in a range of 1:(0.5-1.5), and preferably 1:1.

In some embodiments of the present disclosure, the silane coupling agent solution has a mass concentration of 2% to 4%, and preferably 2% to 3%.

In some embodiments of the present disclosure, the silane coupling agent solution has a pH value of 4 to 6, and preferably 4 to 5. There is no special limitation on a dosage of the acetic acid, as long as the pH value of the system could be within the above range.

In the present disclosure, limiting the mass ratio of the ethanol to the water as well as the mass concentration and the pH value of the silane coupling agent solution within the above ranges could facilitate sufficient hydrolysis of the silane coupling agent.

In some embodiments of the present disclosure, the mixing of the silane coupling agent KH560, the ethanol, the water, and the acetic acid includes: mixing the ethanol and the water to obtain a mixed solution, adding the silane coupling agent KH560, and adding the acetic acid to adjust the pH value.

In some embodiments of the present disclosure, the hydrolysis is conducted for 20 min to 40 min, and preferably 30 min. In some embodiments of the present disclosure, the hydrolysis is conducted at a temperature of 20° C. to 30° C. In some embodiments of the present disclosure, the hydrolysis is conducted under stirring. There are no special limitations on the stirring method and speed, and the stirring method and speed well known to those skilled in the art may be adopted. In the present disclosure, limiting the hydrolysis time within the above range could enable the silane coupling agent to be fully hydrolyzed.

In the present disclosure, a reaction in the hydrolysis is shown in formula I:

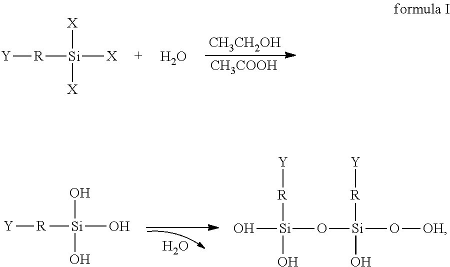

where X is a hydrolyzable group OCH₃, Y is an epoxy functional group, and R is a methyl group.

In the present disclosure, after a silane coupling agent solution is obtained, the silane coupling agent solution with a nanomaterial is mixed, and then subjected to modification to obtain a modified nanomaterial.

In some embodiments of the present disclosure, the nanomaterial includes one or more selected from the group consisting of nano-titania and nano-silica. In some embodiments of the present disclosure, the nano-titania has a specific surface area of 20 m²/g to 50 m²/g; the nano-silica has a specific surface area of 220 m²/g to 280 m²/g.

In some embodiments of the present disclosure, the nanomaterial has a particle size of 10 nm to 20 nm, and preferably 15 nm.

In some embodiments of the present disclosure, a mass ratio of the nanomaterial to the silane coupling agent solution is in a range of (5-20):100, and preferably (10-20):100. In the present disclosure, limiting the mass ratio of the nanomaterial to the silane coupling agent solution within the above range could enable a surface of the nanomaterial to be modified with more of the silane coupling agent, thus further improving modification effect.

In some embodiments of the present disclosure, the modification is conducted at a temperature of 20° C. to 30° C. In some embodiments of the present disclosure, the modification is conducted for 3 h to 6 h, and preferably 4 h to 5 h. In some embodiments of the present disclosure, the modification is conducted under stirring. There are no special limitations on the stirring method and speed, and the stirring method and speed well known to those skilled in the art may be adopted. In the present disclosure, limiting the modification temperature and time within the above range could further improve the modification effect of the nanomaterial.

In some embodiments of the present disclosure, after the modification is completed, a modified product obtained is subjected to washing, filtering, drying, and grinding in sequence to obtain the modified nanomaterial.

In the present disclosure, there are no special limitations on the operations of washing, filtering, drying, and grinding. Technical solutions of the washing, filtering, drying, and grinding that are well known to those skilled in the art may be adopted.

In the present disclosure, after a modified nanomaterial is obtained, the modified nanomaterial with a resin and a curing agent is mixed, and then subjected to curing to obtain a silane coupling agent solution-modified nanomaterial-toughened resin matrix.

In some embodiments of the present disclosure, the resin includes epoxy resin or vinyl resin; and the epoxy resin is epoxy resin E51.

In some embodiments, when the resin is the epoxy resin E51, the curing agent is polyamide resin 650; a mass ratio of the epoxy resin E51 to the curing agent is in a range of 1:(0.5-1.5), and preferably 1:1. In some embodiments, when the resin is the epoxy resin E51, a defoaming agent is added during the mixing; the defoaming agent is selected from the group consisting of a silicone oil and a organosilicon defoaming agent; and a mass ratio of the defoaming agent to the epoxy resin E51 is in a range of (0.1-0.5):100.

In some embodiments, when the resin is the vinyl resin, the curing agent is methyl ethyl ketone peroxide. In some embodiments, when the resin is the vinyl resin, an accelerator promoter and a defoaming agent are added during the mixing; the accelerator promoter is cobalt isooctanoate; and the defoaming agent is selected from the group consisting of a silicone oil and a organosilicon defoaming agent. In some embodiments of the present disclosure, a mass ratio of the vinyl resin, the curing agent, the accelerator promoter, and the defoaming agent is in a range of 100:(1-3):(0.5-1.5):(0.1-1), and preferably 100:2:1:0.5.

In some embodiments of the present disclosure, a mass ratio of the modified nanomaterial to the resin is in a range of (1-5):100, and preferably (2-3):100. In the present disclosure, limiting the mass ratio of the modified nanomaterial to the resin within the above range could enable the nanomaterial to be fully and evenly dispersed in the resin to avoid agglomeration, thereby further improving the mechanical properties of the resin matrix.

In some embodiments of the present disclosure, the mixing of the modified nanomaterial, the resin, and the curing agent is conducted at a temperature of 20° C. to 30° C. In some embodiments of the present disclosure, the mixing of the modified nanomaterial, the resin, and the curing agent is conducted for 10 min to 40 min, and preferably 15 min to 30 min. In some embodiments of the present disclosure, the mixing of the modified nanomaterial, the resin, and the curing agent is conducted under stirring. There are no special limitations on the stirring method and speed, and the stirring method and speed well known to those skilled in the art may be adopted.

In some embodiments of the present disclosure, the curing is conducted at a temperature of 20° C. to 30° C. In some embodiments of the present disclosure, the curing is conducted for 12 h to 36 h, and preferably at 24 h. In the present disclosure, limiting the curing temperature and time within the above range could enable the resin to have a suitable curing rate and increase its cross-linking density, thereby further improving the mechanical properties.

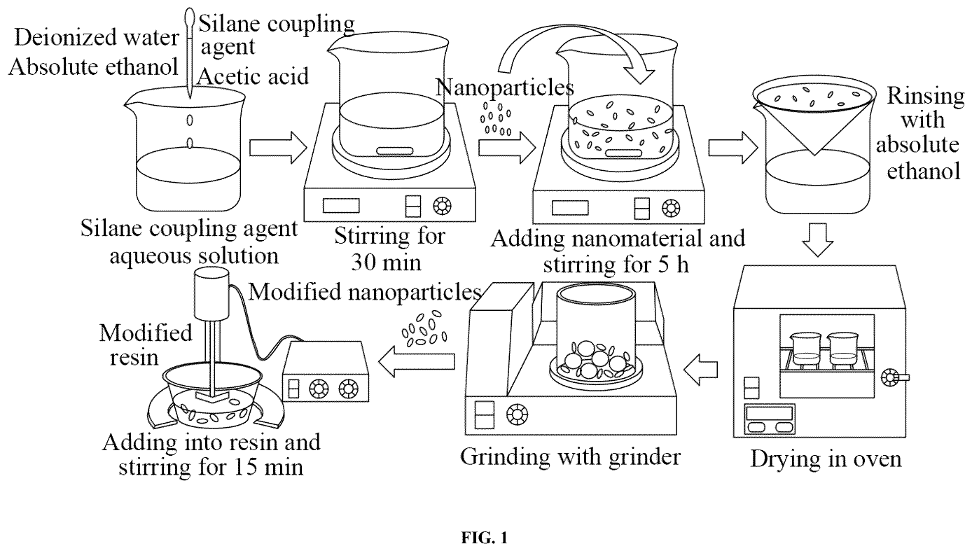

In some embodiments of the example of the present disclosure, a schematic flow chart of the method for preparing the silane coupling agent solution-modified nanomaterial-toughened resin matrix is shown in FIG. 1, including: mixing deionized water, silane coupling agent, absolute ethanol, and acetic acid to obtain a silane coupling agent aqueous solution, stirring for 30 min, adding nanoparticles, stirring for 5 h, rinsing with the absolute ethanol, drying in an oven, and grinding with a grinder to obtain modified nanoparticles, then adding into a resin, and conducting toughening.

In the present disclosure, a specific silane coupling agent KH560 is adopted to modify a nanomaterial to obtain a modified nanomaterial, and a resin matrix is toughened with the modified nanomaterial. The KH560 has two reactive groups, which could effectively modify a surface of the nanomaterial and reduce agglomeration. Meanwhile, molecular chains connected to the surface of the nanomaterial contain epoxy groups that could react with a resin. Moreover, during curing, the epoxy groups do not occupy reaction bond sites between a curing agent and the resin, thereby increasing a cross-linking density of the resin after curing and controlling process parameters such as a dosage of each component, reaction temperature, and time, so as to further improve mechanical properties of the resin matrix.

The present disclosure further provides a silane coupling agent solution-modified nanomaterial-toughened resin matrix prepared by the method described in the above technical solutions.

In the present disclosure, the prepared resin matrix has better mechanical properties.

The present disclosure further provides use of the silane coupling agent solution-modified nanomaterial-toughened resin matrix described in the above technical solutions in a resin matrix composite.

In the present disclosure, there is no special limitation on the operation of the use of the silane coupling agent solution-modified nanomaterial-toughened resin matrix in the resin matrix composite. It is sufficient to adopt technical solutions for the use of resin matrix in resin matrix composite that are well known to those skilled in the art.

The technical solutions of the present disclosure will be clearly and completely described below with reference to the examples of the present disclosure. Apparently, the described examples are merely a part rather than all of the examples of the present disclosure. All other embodiments obtained by those skilled in the art based on the embodiments of the present disclosure without creative efforts shall fall within the scope of the present disclosure.

### Example 1

(1) 2 g of a silane coupling agent KH560 was added into a mixture of 49 g of deionized water and 49 g of absolute ethanol (a mass ratio of the deionized water to the absolute ethanol was 1:1), and a resulting mixture was adjusted to a pH value of 4 to 5 with an appropriate amount of acetic acid. The resulting solution was stirred for 30 min with a magnetic stirrer at room temperature to obtain a silane coupling agent solution with a mass concentration of 2% (a dosage of the acetic acid was extremely low and did not affect a concentration of the silane coupling agent solution).

(2) 20 g of nano-titania (with a particle size of 15 nm, and a specific surface area of 20 m²/g to 50 m²/g) was added into 100 g of the silane coupling agent solution (the nano-titania and the silane coupling agent solution were at a mass ratio of 20:100), and stirred for 5 h with the magnetic stirrer. The resulting system was rinsed and filtered with absolute ethanol and filter paper, respectively. The resulting substance was dried in an oven, and ground with a grinder to obtain a modified nanomaterial.

(3) 3 g of modified nano-titania was added into 100 g of vinyl resin (a mass ratio of the modified nano-titania to the vinyl resin was 3:100), and stirred with a mechanical mixer at 2,000 r/min for 15 min to obtain a mixture solution. The mixture solution was added with 2 g of a curing agent methyl ethyl ketone peroxide, 1 g of cobalt isooctanoate, and 0.5 g of a silicone defoaming agent (a mass ratio of the vinyl resin, the curing agent, the cobalt isooctanoate, and the defoaming agent was 100:2:1:0.5), stirred for another 15 min, and cured at room temperature for 24 h to obtain a modified resin (resin matrix), which was recorded as VESOT3K2.

### Example 2

(1) 3 g of a silane coupling agent KH560 was added into a mixture of 48.5 g of deionized water and 48.5 g of absolute ethanol (a mass ratio of the deionized water to the absolute ethanol was 1:1), and a resulting mixture was adjusted to a pH value of 4 to 5 with an appropriate amount of acetic acid. The resulting solution was stirred for 30 min with a magnetic stirrer at room temperature to obtain a silane coupling agent solution with a mass concentration of 3%.

(2) 20 g of nano-titania (with a particle size of 15 nm, and a specific surface area of 20 m²/g to 50 m²/g) and 10 g of nano-silica (with a particle size of 15 nm, and a specific surface area of 220 m²/g to 280 m²/g) were separately added into 100 g of the silane coupling agent solution (a mass ratio of the nano-titania to the silane coupling agent solution was 20:100, and a mass ratio of the nano-silica to the silane coupling agent solution was 10:100), and stirred for 5 h with the magnetic stirrer. The resulting system was rinsed and filtered with absolute ethanol and filter paper, respectively. The resulting substance was dried in an oven, and ground with a grinder to obtain a modified nanomaterial.

(3) 3 g of modified nano-titania and 1 g of modified nano-silica were added into 100 g of vinyl resin (a ratio of a total mass of the modified nano-titania and the modified nano-silica to a mass of the vinyl resin was 4:100), and stirred with a mechanical mixer at 2,000 r/min for 15 min to obtain a mixture solution. The mixture solution was added with 2 g of a curing agent methyl ethyl ketone peroxide, 1 g of cobalt isooctanoate, and 0.5 g of a silicone defoaming agent (a mass ratio of the vinyl resin, the curing agent, the cobalt isooctanoate, and the defoaming agent was 100:2:1:0.5), stirred for another 15 min, and cured at room temperature for 24 h to obtain a modified resin (resin matrix), which was recorded as VES1T3K3.

### Example 3

(1) 2 g of a silane coupling agent KH560 was added into a mixture of 49 g of deionized water and 49 g of absolute ethanol (a mass ratio of the deionized water to the absolute ethanol was 1:1), and a resulting mixture was adjusted to a pH value of 4 to 5 with an appropriate amount of acetic acid. The resulting solution was stirred for 30 min with a magnetic stirrer at room temperature to obtain a silane coupling agent solution with a mass concentration of 2%.

(2) 20 g of nano-titania (with a particle size of 15 nm, and a specific surface area of 20 m²/g to 50 m²/g) and 10 g of nano-silica (with a particle size of 15 nm, and a specific surface area of 220 m²/g to 280 m²/g) were separately added into 100 g of the silane coupling agent solution (a mass ratio of the nano-titania to the silane coupling agent solution was 20:100, and a mass ratio of the nano-silica to the silane coupling agent solution was 10:100), and stirred for 5 h with the magnetic stirrer. The resulting system was rinsed and filtered with absolute ethanol and filter paper, respectively. The resulting substance was dried in an oven, and ground with a grinder to obtain a modified nanomaterial.

(3) 1 g of modified nano-titania and 1 g of modified nano-silica were added into 50 g of epoxy resin E51 (a ratio of a total mass of the modified nano-titania and the modified nano-silica to a mass of the epoxy resin E51 was 4:100), added with 0.25 g of a silicone defoaming agent (a mass ratio of the epoxy resin and the defoaming agent was 0.5:100), and stirred with a mechanical mixer at 2,000 r/min for 15 min to obtain a mixture solution. The mixture solution was added with 50 g of a curing agent low-molecular polyamide resin 650 (a mass ratio of 1:1 the epoxy resin and the curing agent was 1:1), stirred for another 15 min, and cured at room temperature for 24 h to obtain a modified resin (resin matrix), which was recorded as EPS1T1K2.

### Comparative Example 1

The modified nano-titania in Example 1 was not added, and 2 g of a curing agent methyl ethyl ketone peroxide, 1 g of cobalt isooctanoate, and 0.5 g of a silicone defoaming agent (a mass ratio of the vinyl resin, the curing agent, the cobalt isooctanoate, and the defoaming agent was 100:2:1:0.5) were added into 100 g of vinyl resin, stirred for 15 min, and cured at room temperature for 24 h to obtain a modified resin (resin matrix), which was recorded as VES0T0K0.

### Comparative Example 2

The modified nano-titania and modified nano-silica in Example 3 were not added, and 50 g of a curing agent low-molecular polyamide resin 650 was added into 50 g of epoxy resin E51 (a mass ratio of the epoxy resin to the curing agent was 1:1), stirred for 15 min, and cured at room temperature for 24 h to obtain a modified resin (resin matrix), which was recorded as EPS0T0K0.

### Comparative Example 3

3 g of nano-titania and 3 g of nano-silica were added into 50 g of epoxy resin E51 (a ratio of a total mass of the nano-titania and the nano-silica and a mass of the epoxy resin E51 was 6:100), and stirred with a mechanical mixer at 2,000 r/min for 15 min to obtain a mixture solution. The mixture solution was added with 0.25 g of a silicone defoaming agent (a mass ratio of the epoxy resin to defoaming agent was 0.5:100), then added with 50 g of a curing agent low-molecular polyamide resin 650 (a mass ratio of the epoxy resin to the curing agent was 1:1), stirred for another 15 min, and cured at room temperature for 24 h to obtain a modified resin (resin matrix), which was recorded as EPS3T3K0.

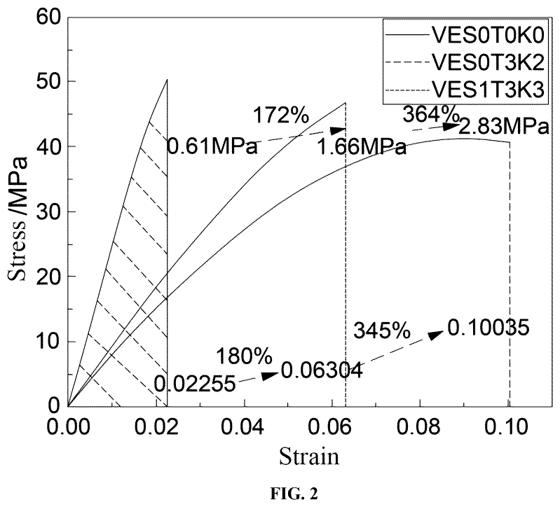

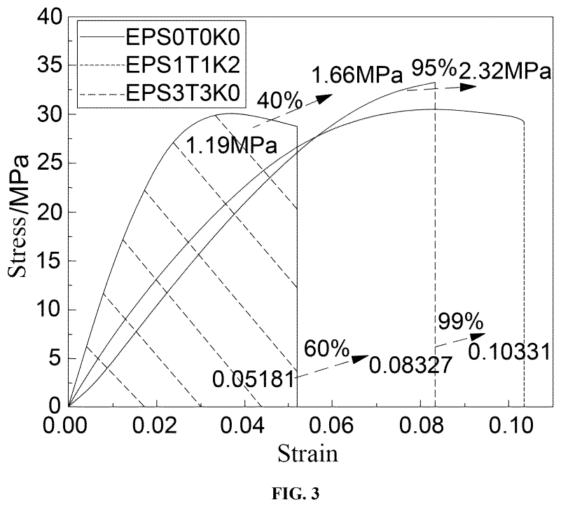

A tensile test was conducted on the resin matrix separately prepared in Example 1, Example 2, and Comparative Example 1, and the tensile stress-strain curves are shown in FIG. 2. The tensile test was conducted on the resin matrix separately prepared in Example 3 and Comparative Examples 2 to 3, and the tensile stress-strain curves are shown in FIG. 3. As shown in FIG. 2 and FIG. 3, the tensile strength of a modified resin is not greatly improved, but the ultimate strain is increased and the ductility is greatly improved. The data below in the figure represent the ultimate strain of the corresponding sample, while the data above in the figure represent the area surrounded by the stress-strain curve of the corresponding sample. The tensile toughness of the resin is characterized by an area enclosed by the stress-strain curve. It is found that the toughness of the resin is increased significantly, toughness of the epoxy resin is increased by 95%, and ductility is increased by 99%; toughness of vinyl resin is increased by 364% and the ductility is increased by 345%. This indicates that the present disclosure solves a problem of high brittleness of the resin matrix.

The above descriptions of embodiments are merely provided to help understand the method of the present disclosure and a core idea thereof. It should be noted that a person of ordinary skill in the art may further make several improvements and modifications without departing from the principle of the present disclosure, but such improvements and modifications should also fall within the protection scope of the present disclosure. Various amendments to these embodiments are apparent to those of professional skill in the art, and the general principles defined herein may be implemented in other embodiments without departing from the spirit or scope of the present disclosure. Accordingly, the present disclosure will not be limited to these embodiments shown herein, but is to fall within the widest scope consistent with the principles and novel features disclosed herein.

1. A method for preparing a silane coupling agent solution-modified nanomaterial-toughened resin matrix, comprising the following steps:
(1) mixing silane coupling agent KH560, ethanol, water, and acetic acid, and conducting hydrolysis to obtain a silane coupling agent solution;
(2) mixing the silane coupling agent solution obtained in step (1) with a nanomaterial, and conducting modification to obtain a modified nanomaterial; and
(3) mixing the modified nanomaterial obtained in step (2) with a resin and a curing agent, and conducting curing to obtain the silane coupling agent solution-modified nanomaterial-toughened resin matrix.

2. The method of claim 1, wherein the silane coupling agent solution in step (1) has a mass concentration of 2% to 4%.

3. The method of claim 1, wherein in step (1), a mass ratio of the ethanol to the water is in a range of 1:(0.5-1.5).

4. The method of claim 1, wherein the silane coupling agent solution in step (1) has a pH value of 4 to 6.

5. The method of claim 1, wherein the nanomaterial in step (2) comprises one or more selected from the group consisting of nano-titania and nano-silica.

6. The method of claim 1, wherein the nanomaterial in step (2) has a particle size of 10 nm to 20 nm.

7. The method of claim 5, wherein the nano-titania has a specific surface area of 20 m²/g to 50 m²/g.

8. The method of claim 5, wherein the nano-silica has a specific surface area of preferably 220 m²/g to 280 m²/g.

9. The method of claim 1, wherein in step (2), a mass ratio of the nanomaterial to the silane coupling agent solution is in a range of (5-20):100.

10. The method of claim 1, wherein the modification in step (2) is conducted for 3 h to 6 h.

11. The method of claim 1, wherein in step (3), a mass ratio of the modified nanomaterial to the resin is in a range of (1-5):100.

12. The method of claim 1, wherein the resin in step (3) comprises epoxy resin or vinyl resin.

13. The method of claim 1, wherein the curing in step (3) is conducted at a temperature of 20° C. to 30° C. for 12 h to 36 h.

14. A silane coupling agent solution-modified nanomaterial-toughened resin matrix prepared by the method of claim 1.

15. A resin matrix composite, comprising the silane coupling agent solution-modified nanomaterial-toughened resin matrix of claim 14.

16. The method of claim 5, wherein the nanomaterial in step (2) has a particle size of 10 nm to 20 nm.

17. The method of claim 2, wherein in step (2), a mass ratio of the nanomaterial to the silane coupling agent solution is in a range of (5-20):100.

18. The silane coupling agent solution-modified nanomaterial-toughened resin matrix of claim 14, wherein the silane coupling agent solution in step (1) has a mass concentration of 2% to 4%.

19. The silane coupling agent solution-modified nanomaterial-toughened resin matrix of claim 14, wherein in step (1), a mass ratio of the ethanol to the water is in a range of 1:(0.5-1.5).

20. The silane coupling agent solution-modified nanomaterial-toughened resin matrix of claim 14, wherein the silane coupling agent solution in step (1) has a pH value of 4 to 6.
